(19) United States
(12) Patent Application Publication
(10) Pub. No.: US 2004/0221990 A1
(43) Pub. Date: Nov. 11, 2004

(54) Methods and compositions for compensating for cement hydration volume reduction

(76) Inventors: James F. Heathman, Houston, TX (US); Krishna M. Ravi, Kingwood, OK (US)

Correspondence Address: CRAIG W. RODDY, HALLIBURTON ENERGY SERVICES, P.O. BOX 1431, DUNCAN, OK, 73536-0440, US

(21) Appl. No.: 10/429,506

(22) Filed: May 5, 2003

(51) Int. Cl. C04B 16/08; C04B 20/00; C04B 38/00; E21B 33/13

(52) U.S. Cl. 166/292; 106/672

(57) ABSTRACT

A method and cementing composition that includes gas generating additives for compensating for or offsetting hydration volume shrinkage of the cementing compositions. The method comprises placing the cementing composition in a subterranean zone and allowing the cement composition to set into a solid mass therein.

### BACKGROUND

The present embodiment relates generally to methods and compositions for compensating for cement hydration volume reduction.

In the drilling and completion of an oil or gas well, a cementing composition is often introduced in the well bore for cementing pipe string or casing. In this process, known as “primary cementing,” the cementing composition is pumped into the annular space between the walls of the well bore and the casing. The cementing composition sets in the annular space, supporting and positioning the casing, and forming a substantially impermeable barrier, or cement sheath, which isolates the well bore into subterranean zones. For instance, see FIG. 1 which depicts an intact cement sheath 10 emplaced in the annular space between the walls of the well bore 12 and the casing 14. The objective of primary cementing is to prevent the undesirable migration of fluids between such subterranean zones.

Generally, there are two primary factors that contribute to ensuring zonal isolation during the life of a well. Specifically, the cement should be placed in the entire annulus through efficient mud removal and the properties of the set cement should be optimized so that it can withstand the stresses from various operations that may be conducted during the life of the well.

If the short-term properties of the cementing composition, such as density, static gel strength, and rheology are designed as needed, the undesirable migration of fluids between zones is prevented immediately after primary cementing. However, changes in pressure or temperature in the well bore over the life of the well can compromise zonal integrity. Also, operations or activities undertaken in the well bore, such as pressure testing, well completion operations, hydraulic fracturing, and hydrocarbon production can affect zonal integrity. Compromised zonal isolation is often the result of cracking or plastic deformation in the cementing composition, or de-bonding between the cementing composition and either the well bore or the casing. Compromised zonal isolation affects safety and requires expensive remedial operations, which can comprise introducing a sealing composition into the well bore to reestablish a seal between the zones.

Conventional cement compositions have the limitation that they shrink during cement hydration if an external source of fluid, for example, water, is not available. The shrinkage of the cement can result in the above-mentioned stresses that lead to damage of the cement sheath. For instance, see FIG. 2 which depicts a cement sheath 20 emplaced in the annular space between the walls of the well bore 22 and the casing 24 in which the cement sheath 20 was damaged during hydration and exhibits cracks 26. In some instances, such as certain combinations of depth and formation properties, even when external fluid is available, the cement sheath may become stressed during cement hydration and may not be able to withstand subsequent well operations.

Therefore, a cementing composition that can compensate for cement hydration volume reduction, is desirable for cementing operations.

### BRIEF DESCRIPTION OF THE DRAWINGS

FIG. 1 is a sectional view of an intact cement sheath formed in the annular space between the walls of a well bore and the casing.

FIG. 2 is a sectional view of a damaged cement sheath exhibiting cracks formed in the annular space between the walls of a well bore and the casing.

FIG. 3 is a schematic drawing of laboratory apparatus for measuring the volumetric expansion of a substance.

FIG. 4 is a graphical representation of data showing the volumetric expansion capability of a system indirectly by measuring its compressibility at high-temperature and high-pressure conditions.

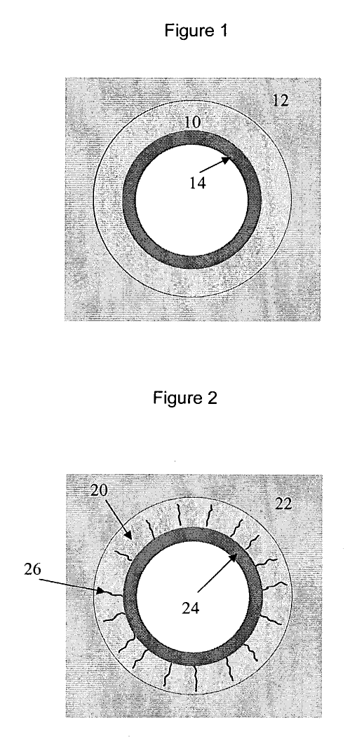

### DESCRIPTION

A cementing composition that includes gas generating additives for compensating for or offsetting hydration volume shrinkage of the cementing compositions. By providing in situ gas generation in optimized concentrations, the gas generating additives compensate for cement hydration volume reduction by compensating for cement sheath pore pressure reduction. Exemplary components that can provide for the necessary gas generation are aluminum powder which generates hydrogen gas and azodicarbonamide which generates nitrogen gas.

The preferred gas generation component is aluminum powder for generating hydrogen gas. A suitable aluminum powder gas generation component is commercially available from Halliburton Company under the trade name Super CBL. Super CBL includes finely ground aluminum to generate hydrogen gas. The reaction by which aluminum generates hydrogen gas relies on the alkalinity of the cement and generally proceeds according to the following reaction:

2Al₍ₛ₎+2OH⁻_{(aq)}+6H₂O→2Al(OH)₄⁻_{(aq)}+3H_{2(g)}

Preferably, the reaction of the gas generating additive to generate gas such as hydrogen or nitrogen occurs before and/or during the transition time of the cement hydration process. The transition time of the cement gelation and hydration process is generally defined as the period in which the gel strength of the cement is between about 100 lb/100 ft² and 500 lb/100 ft². These values that define the boundaries of the slurry transition period are statistical averages and are shown for example only. More precise values of gel strength that define the actual boundaries of the transition period may be calculated for specific wellbore conditions and applications.

Also, when the gas generating additive is aluminum powder, it is preferable to retard the reaction rate of aluminum powder mixed with oil field cements so that the generation of hydrogen gas therein is delayed. According to the foregoing the reaction rate of the aluminum powder with the oil field cement is delayed by coating or encapsulating the aluminum powder. The coating serves to function as an inhibitor to the reaction between the aluminum powder and water-soluble hydroxides of the cement slurry and may be any suitable coating such as fatty acid esters of sorbitan, glycerol and/or pentaerythritol. As will be understood, an effective quantity of one or more of such esters is first dissolved in an organic solvent which can subsequently be evaporated and removed under vacuum. The resulting inhibitor solution is then combined with a quantity of aluminum powder whereby the aluminum powder is wetted with the solution followed by vacuum evaporation of the solvent and vacuum drying of the aluminum powder.

Particularly suitable fatty acid esters which have high surface activity and function to inhibit the reactivity of aluminum powder are those selected from the group consisting of sorbitan monooleate, sorbitan monoricinoleate, sorbitan monotallate, sorbitan monoisostearate, sorbitan monostearate, glycerol monoricinoleate, glycerol monostearate, pentaerythritol monoricinoleate, and mixtures of such inhibitors. Of these, sorbitan monooleate is most preferred. In this regard, reference is made to U.S. Pat. No. 4,565,578, the entire disclosure of which is hereby incorporated herein by reference.

As noted above, the aluminum powder may also be encapsulated to inhibit the reaction rate of the aluminum powder mixed with oil field cements. In this regard, reference is made to U.S. Pat. No. 6,444,316, the entire disclosure of which is hereby incorporated herein by reference.

The gas generating additives for compensating for hydration volume reduction can be either dry blended with cement or injected as a liquid suspension into the cement slurry while it is being pumped down the wellbore. The concentration of the additive preferably ranges from about 0.2% to 5.0% by weight of cement.

There are often cases when the cement slurry either needs to be batch mixed and held at the surface for a certain length of time, such as for instance from 30 minutes to 6 hours or for several days. Cements are often batch mixed in instances where large volumes of cement are needed and uniformity of the slurry properties are important. Cements are also batch mixed in instances of equipment related problems or when the slurry will be held for a considerable time on the surface such as when extensive on-location lab testing will be conducted, or as disclosed in U.S. Pat. No.4,676,832 the entire disclosure of which is hereby incorporated by reference, wherein a cement slurry may be held for an undetermined period of time in its liquid state. In such instances, there is a risk that the gas generating additives will react during the time period that the cement slurry is being held at the surface. Accordingly, it is preferred that the gas generating additive be suspended in a liquid medium and injected into the cement slurry as the cement slurry is being pumped into the wellbore. It will be understood that the gas generating additive may be injected into the mix water prior to slurry preparation, as the slurry is being mixed, into the mixed slurry while still in the batch mixer, or injected directly into the slurry on the fly with an injection pump while being pumped down hole.

According to this embodiment, the liquid medium to be injected into the cement composition includes a suitable liquid medium, a biocide, a thickener, an inhibitor and the gas generating additive. The suspension is injected into the cement slurry as the slurry is being pumped into the wellbore by a suitable pump with the aid of a metering and control system.

The liquid medium may be any suitable liquid medium well known to those of ordinary skill in the art such as water, mineral oils including low and high aromatic mineral oils, such as Escaid 110 which is commercially available from Exxon Mobil Corporation, vegetable oils such as those disclosed in U.S. Pat. No.5,921,319, the entire disclosure of which is hereby incorporated by reference, hydrocarbons such as kerosene, diesel, fuel oil and the like, synthetic fluids such as esters, including those disclosed in U.S. Pat. Nos. Re 36,066, 5,461,028, 5,254,531, 5,252,554 and 5,232,910, the entire disclosures of which are hereby incorporated herein by reference, internal olefins, polyalphaolefins and paraffins such as those disclosed in U.S. Pat. Nos. 6,165,945, 5,671,810 and 5,605,879, as well as blends, combinations and mixtures thereof. Those of ordinary skill in the art will understand that other suitable synthetic fluids include those disclosed in Society of Professional Engineers (“SPE”) Paper No. 50726 entitled “Impact of Synthetic-Based Drilling Fluids on Oilwell Cementing Operations” by Patel et al. 1999, the entire disclosure of which is hereby incorporated by reference. Those skilled in the art will also recognize that ethylene glycol and propylene glycol may also be used as the liquid medium. Reference in this regard is made to an composition of aluminum powder and ethylene glycol which is which is commercially available from Halliburton Energy Services, Inc. under the trade name of GasChek. The water used to form the slurry is present in an amount sufficient to make the slurry pumpable for introduction down hole. The water used to form the slurry as well as the liquid medium of the present embodiment can be fresh water or salt water. The term “salt water” is used herein to mean salt solutions ranging from unsaturated salt solutions to saturated salt solutions, including brines and seawater. Generally, any type of water can be used, provided that it does not contain an excess of compounds well known to those skilled in the art, that adversely affect properties of the cementing composition. Generally, the water is present in the cement compositions in an amount in the range of from about 35% to about 65% by weight of the cement therein.

The biocide may be any suitable biocides well known to those of ordinary skill in the art such as those disclosed in U.S. Pat. No. 5,955,401 the entire disclosure of which is hereby incorporated herein by reference.

The thickener may be any suitable and conventional thickener well known to those of ordinary skill in the art. Such thickeners may include polymers such as natural and derivatized polysaccharides which are soluble, dispersible or swellable in an aqueous liquid to viscosify or thicken the liquid as well as natural and synthetic water-hydratable clays such as bentonite, attapulgite and laponite, and thickeners and/or viscosity indexers that are known in the art such as organophilic clays for the nonaqueous carriers.

Polymers which are suitable for use as a thickener in accordance with the present embodiment include polymers which contain, in sufficient concentration and reactive position, one or more hydroxyl, cis-hydroxyl, carboxyl, sulfate, sulfonate, amino or amide functional groups. Particularly suitable polymers include polysaccharides and derivatives thereof which contain one or more of the following monosaccharide units: galactose, mannose, glucoside, glucose, xylose, arabinose, fructose, glucuronic acid or pyranosyl sulfate. Natural polymers containing the foregoing functional groups and units include guar gum and derivatives thereof, locust bean gum, tara, konjak, tamarind, starch, cellulose, karaya gum, xanthan gum, tragacanth gum, arabic gum, ghatti gum, tamarind gum, carrageenan and derivatives thereof. Modified gums such as carboxyalkyl derivatives, like carboxymethyl guar, and hydroxyalkyl derivatives, like hydroxypropyl guar can also be used. Doubly derivatized gums such as carboxymethylhydroxypropyl guar (CMHPG) can also be used.

Synthetic polymers and copolymers which contain the above-mentioned functional groups and which can be utilized as a thickener include, but are not limited to, polyacrylate, polymethacrylate, polyacrylamide, maleic anhydride, methylvinyl ether copolymers, polyvinyl alcohol and polyvinylpyrrolidone.

Modified celluloses and derivatives thereof, for example, cellulose ethers, esters and the like can also be used as the thickener. In general, any of the water-soluble cellulose ethers can be used. Those cellulose ethers include, among others, the various carboxyalkylcellulose ethers, such as carboxyethylcellulose and carboxymethylcellulose (CMC); mixed ethers such as carboxyalkylethers, e.g., carboxymethylhydroxyethylcellulose (CMHEC); hydroxyalkylcelluloses such as hydroxyethylcellulose (HEC) and hydroxypropylcellulose; alkylhydroxyalkylcelluloses such as methylhydroxypropylcellulose; alkylcelluloses such as methylcellulose, ethylcellulose and propylcellulose; alkylcarboxyalkylcelluloses such as ethylcarboxymethylcellulose; alkylalkylcelluloses such as methylethylcellulose; hydroxyalkylalkylcelluloses such as hydroxypropylmethylcellulose; and the like.

Preferred thickeners according to the present embodiment include hydroxyethylcellulose (HEC), carboxymethylhydroxyethylcellulose (CMHEC) and guar gum.

As will be understood, the amount of the thickener included in the liquid medium of the present embodiment can vary depending upon the temperature of the zone to be cemented and the particular pumping time required. Generally, the thickener is included in the liquid medium in an amount of from about 0.05% to 5.0% by weight of cement in the composition.

A variety of cements can be used with the present embodiment, including cements comprised of calcium, aluminum, silicon, oxygen, and/or sulfur, which set and harden by reaction with water (“hydraulic cements”). Such hydraulic cements include Portland cements, pozzolan cements, gypsum cements, aluminous cements, silica cements, and alkaline cements. Portland cements or their equivalents are generally preferred for use in accordance with the present invention when performing cementing operations in subterranean zones penetrated by well bores. Portland cements of the types defined and described in API Specification For Materials and Testing For Well Cements, API Specification 10, 5^{th} Edition, Jul. 1, 1990, of the American Petroleum Institute (the entire disclosure of which is hereby incorporated as if reproduced in its entirety) are preferred. Preferred API Portland cements include Classes A, B, C, G, and H, of which API Classes A, G and H are particularly preferred for the present embodiment. It is understood that the desired amount of cement is dependent on the volume required for the sealing operation.

A variety of other well known additives may be added to the cementing composition to alter its physical properties. It will be understood that such additives may include slurry density modifying materials (e.g., silica flour, silica fume, sodium silicate, microfine sand, iron oxides and manganese oxides), dispersing agents, set retarding agents, set accelerating agents, fluid loss control agents, strength retrogression control agents, weighting materials such as barium sulfate (barite), and viscosifying agents well known to those skilled in the art.

Methods of this embodiment for cementing a subterranean zone penetrated by a well bore include forming a cement slurry as described herein, forming a liquid composition including a gas generating additive as described herein, injecting the liquid composition into the cement slurry as the cement slurry is pumped into the subterranean zone to be cemented by way of the well bore and then allowing the cement slurry with the injected liquid composition to set into a hard impermeable mass therein.

Another method of the embodiment includes preparing a pumpable cement slurry, offsetting the hydration volume shrinkage of the cement slurry by including an effective amount of an active gas generating additive in the cement slurry to reduce cement hydration volume shrinkage, placing the slurry in the subterranean zone to be cemented, and allowing the slurry to set into a hard impermeable mass.

A preferred method of the embodiment for cementing a conductor pipe in a well bore comprises the steps of preparing the well cement slurry, injecting a liquid composition including a gas generating additive into the cement slurry, introducing the cement slurry and liquid composition into the conductor pipe whereby they are caused to flow through the pipe and return from the lower end thereof through an annulus present between the pipe and the well bore to the surface of the earth, and maintaining the slurry in the annulus for a sufficient time to enable the slurry to form a rigid cement sheath whereby influx of fluids into the well bore is prevented.

In order to further illustrate the methods and cement compositions of this embodiment, the following examples are given.

### EXAMPLE 1

A cement slurry was prepared at ambient temperature and pressure by mixing a 16.4 lb/gal slurry of Class H cement and deionized water (400 g. cement and 150 g. deionized water). The slurry was poured into a 500 mL glass beaker. The level of the slurry was marked on the beaker. To the beaker was then added 2 g. of a 0.5% by weight of cement composition of Super CBL aluminum powder and the mixture was stirred with a non-metal spatula for 30 seconds. The cement slurry containing the Super CBL aluminum powder was observed for the presence of bubbles and volume increase. The production of bubbles is an indication that the reaction of the aluminum powder to produce hydrogen gas has commenced. No bubbles were observed until about 180 minutes after mixing the Super CBL aluminum powder with the cement slurry. The mixture experienced maximum expansion of about 16 mm in the beaker after about 360 minutes.

### EXAMPLE 2

A 15.9 lb/gal cement slurry of Class H cement was prepared according to the procedure set forth in Example 1. To the cement slurry was added 0.5% Super CBL aluminum powder by weight of the cement and the mixture was placed in a silicone Hassler sleeve to monitor volume changes as the cement was hydrating. The cement slurry was heated to 80° F. and subjected to a pressure of 1000 psi. The volume of the cement slurry remained almost constant which demonstrated that the Super CBL contained in the cement slurry was generating sufficient hydrogen gas to compensate for the shrinkage of the cement that normally occurs as the hydration of the cement proceeds.

### EXAMPLE 3

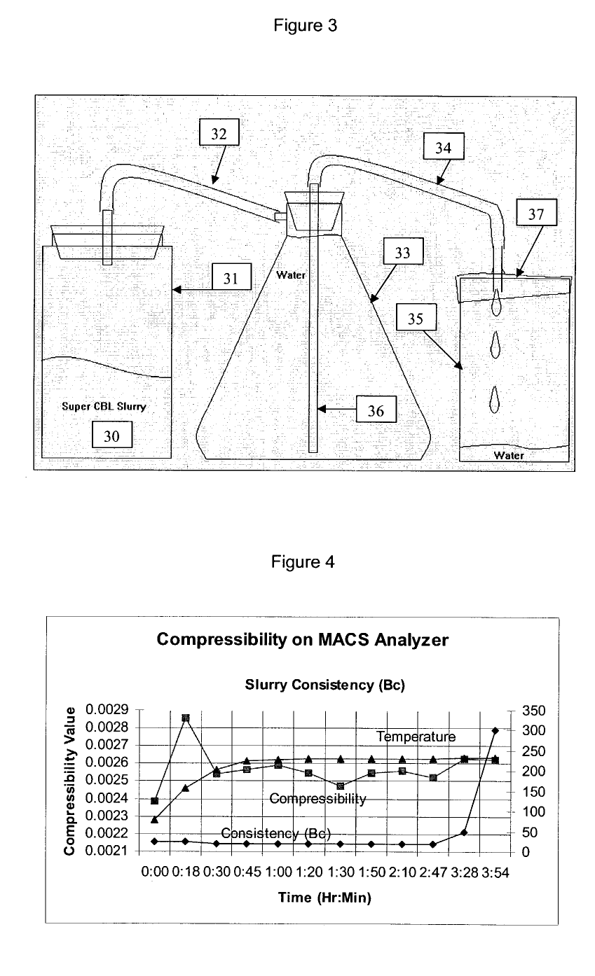

An 18.61 lb/gal cement slurry of Class H cement was prepared according to the procedure set forth in Example 1. To the cement slurry was added 0.4% Super CBL aluminum powder by weight of the cement and a volume 30 of the resultant slurry was placed in sealed flask 31 as shown in FIG. 3. The cement slurry also included the following components: 35% SSA-2 a crystalline silica strength retrogression preventer, 37 lb/sk of Hi-Dense No. 4, a hematite slurry weighting material, 0.4% HALAD®-344, a 2-acrylamide-2-propane sulfonic acid and N,N-dimethyl acrylamide random copolymer fluid loss additive, 0.4% HALAD-413, a caustized lignite grafted with 2-acrylamide-2-methylsulfonic acid, N,N-dimethylacrylamide and acrylamide fluid loss additive, 0.3% CFR-3 a sulfonated acetone formaldehyde condensate slurry dispersant and 0.2% SCR-100 a 2-acrylamide-2-methylsulfonic acid and acrylic acid random copolymer slurry hydration retarder each of which is commercially available from Halliburton Energy Services, Inc. The cement slurry further included water at the rate of 5.2 gal/sk to give a yield of 1.50 cu ft/sk. The apparatus depicted in FIG. 3 was utilized to measure the volumetric expansion of the volume of the cement slurry 30 while not in the presence of water external to the slurry being tested. Tube 32 connected the sealed flask 31 to the top of sealed flask 33 containing water. As the cement slurry 30 expanded it forced gas from sealed flask 31 through tube 32 and into sealed flask 33. Tube 34 connected sealed flask 33 to an open measuring device 35. Riser tube 36 prevented the gas from tube 32 from entering tube 34 and forced water from sealed flask 33 into tube 34 as volumetric changes occurred in sealed flask 31. Water from sealed flask 33 was thereby forced through tubes 36 and 34 into open measuring device 35 covered with evaporation shield 37. Device 35 was a volumetric container as depicted in FIG. 3, or could also be a digital scale capable of accurately measuring the water extruding from sealed flask 33. It will be understood by those of ordinary skill in the art that the apparatus depicted in FIG. 3 could also be modified to allow measurement of slurry volume shrinkage as well.

For the period of time shown in the data set forth in Table 1, the volume of water displaced from sealed flask 33 to measuring device 35 via tubes 36 and 34 was monitored. This volume is shown as the displaced volume in Table 1. As set forth in Table 1, the test was performed four times. The slurry was conditioned by two different methods and under two different temperatures as shown in Table 1 to illustrate the effect that temperature can have on the early as well as long-term reaction rate at atmospheric pressure.

TABLE 1

| | | Time | | |
|---|---|---|---|---|
| | | (hr: | Slurry Volume | Displaced |
| Conditioning | Curing | min) | (fluid ounces/ml) | Volume (ml) |
| Immediately | Benchtop at | 0 | 9.0/266 | 0 |
| after mixing | room | 0:55 | 9.5/281 | Not Measurable |
| in Waring | temperature | 1:00 | 10.0/295 | Not Measurable |
| Blender | | 1:15 | 13.0/384 | 130 |
| | | 2:00 | Full | 300 |
| | | 7:45 | Full | 375 |
| | 180° F. | 0 | 9.0/266 | 0 |
| | Water bath | 0:10 | Unable to See | Reacting |
| | | 1:00 | Markings while in | 420 |
| | | 1:15 | Bath | 450 |
| | | 7:45 | | 725 |
| 5 minutes on | Benchtop at | 0 | 6.0/177 | 0 |
| Atmospheric | room | 1:06 | 6.5/192 | Not Measurable |
| Consisto- | temperature | 1:50 | 7.0/207 | Not Measurable |
| meter | | 7:10 | 10.0/296 | Not Measurable |
| preheated to | 180° F. | 0 | 6.0/177 | 0 |
| 180° F. | Water Bath | 0:02 | Unable to See | 100 |
| (slurry | | 0:20 | Markings while in | 150 |
| temperature | | 0:45 | Bath | 150 |
| at transfer | | 1:30 | | 150 |
| measured at | | 7:10 | | 150 |
| 165° F.) | | | | |

The data in Table 1 demonstrate that the reaction of the Super CBL aluminum powder is delayed at room temperature as desired and is properly delayed for mixing and does not start to react until after a certain time has passed, and that the reaction rate is greatly accelerated by increasing the temperature.

### EXAMPLE 4

The cement slurry described in Example 3 was placed in a high-temperature, high-pressure (“HTHP”) slurry testing device known as a MACS Analyzer, which is commercially available from Halliburton Energy Services, that allows periodic examination of slurry compressibility by decompressing the slurry and measuring the resulting volume change. This volume change is used in conjunction with the initial slurry volume to calculate a compressibility value. In accordance with the preferred embodiments, this method is used to illustrate the expansive capabilities of a slurry containing in situ gas-generating additives. In this example, the compressibility test depicted in FIG. 4 was conducted while the temperature was increased from 80° F. to 224° F. in 35 minutes. The pressure was increased in conjunction with the temperature as is normally done to simulate wellbore conditions from 500 psi to 12,000 psi. Once the test pressure reached 12,000 psi, it was held constant except for the indicated data points where the pressure was decreased to 90% of test pressure to obtain the apparent compressibility of the slurry.

Although only a few exemplary embodiments of this embodiment have been described in detail above, those skilled in the art will readily appreciate that many other modifications are possible in the exemplary embodiments without materially departing from the novel teachings and advantages of this embodiment. Accordingly, all such modifications are intended to be included within the scope of this embodiment as defined in the following claims.

1. A method of cementing a subterranean zone, comprising:
preparing a cement slurry;
preparing a liquid composition comprising an active gas generating additive selected from the group consisting of aluminum powder and azodicarbonamide, wherein the active gas generating additive is coated or encapsulated with a surfactant and the surfactant is a fatty acid ester of sorbitan, glycerol or pentaerythritol;
pumping the cement slurry into the subterranean zone;
injecting the liquid composition into the cement slurry to form a cementing composition as the cement slurry is being pumped into the subterranean zone; and
allowing the cementing composition to set in the subterranean zone.

2. The method of claim 1 wherein the surfactant is selected from the group consisting of sorbitan monooleate, sorbitan monoricinoleate, sorbitan monotallate, sorbitan monoisostearate, sorbitan monostearate, glycerol monoricinoleate, glycerol monostearate, pentaerythritol monoricinoleate, and mixtures thereof.

3. The method of claim 2 wherein the surfactant comprises sorbitan monooleate.

4. The method of claim 1 wherein the cement slurry comprises Portland cement, pozzolan cement, gypsum cement, aluminous cement, silica cement, or alkaline cement.

5. The method of claim 1 wherein the cement slurry comprises class A, G or H Portland cement.

6. The method of claim 1 wherein the cementing composition comprises from about 0.3 to about 5.0 percent of the active gas generating additive by weight of the cement.

7. The method of claim 1 wherein the cementing composition comprises greater than about 2.0 percent of the active gas generating additive by weight of the cement.

8. The method of claim 1 wherein the liquid composition comprises a liquid medium selected from the group consisting of water, low aromatic mineral oil, high aromatic mineral oil, vegetable oil, kerosene, diesel, fuel oil, esters, internal olefins, polyalphaolefins, paraffins, ethylene glycol, propylene glycol and mixtures thereof.

9. The method of claim 1 wherein the liquid composition further comprises a biocide, a thickener and an inhibitor.

10. The method of claim 9 wherein the thickener comprises a polymeric material selected from the group consisting of guar gum and derivatives thereof, locust bean gum, tara, konjak, tamarind, starch, cellulose, karaya gum, xanthan gum, tragacanth gum, arabic gum, ghatti gum, tamarind gum, carrageenan and derivatives thereof, carboxymethyl guar, hydroxypropyl guar, carboxymethylhydroxypropyl guar, polyacrylate, polymethacrylate, polyacrylamide, maleic anhydride, methylvinyl ether copolymers, polyvinyl alcohol, polyvinylpyrrolidone, carboxyethylcellulose, carboxymethylcellulose, carboxymethylhydroxyethylcellulose, hydroxyethylcellulose, hydroxypropylcellulose, methylhydroxypropylcellulose, methylcellulose, ethylcellulose, propylcellulose, ethylcarboxymethylcellulose, methylethylcellulose, hydroxypropylmethylcellulose, bentonite, attapulgite and laponite.

11. The method of claim 10, wherein the thickener is selected from the group consisting of hydroxyethylcellulose, carboxymethylhydroxyethylcellulose and guar gum.

12. A method of cementing a subterranean zone, comprising:
preparing a cement slurry;
preparing a liquid composition comprising from about 0.3 to about 5.0 percent of an active gas generating additive by weight of the cement wherein the active gas generating additive is selected from the group consisting of aluminum powder and azodicarbonamide;
pumping the cement slurry into the subterranean zone;
injecting the liquid composition into the cement slurry to form a cementing composition as the cement slurry is being pumped into the subterranean zone; and
allowing the cementing composition to set in the subterranean zone.

13. The method of claim 12, wherein the active gas generating additive is coated or encapsulated with a surfactant and the surfactant is a fatty acid ester of sorbitan, glycerol or pentaerythritol.

14. The method of claim 13 wherein the surfactant is selected from the group consisting of sorbitan monooleate, sorbitan monoricinoleate, sorbitan monotallate, sorbitan monoisostearate, sorbitan monostearate, glycerol monoricinoleate, glycerol monostearate, pentaerythritol monoricinoleate, and mixtures thereof.

15. The method of claim 14 wherein the surfactant comprises sorbitan monooleate.

16. The method of claim 12 wherein the cement slurry comprises Portland cement, pozzolan cement, gypsum cement, aluminous cement, silica cement, or alkaline cement.

17. The method of claim 12 wherein the cement slurry comprises class A, G or H Portland cement.

18. The method of claim 12 wherein the liquid composition comprises a liquid medium selected from the group consisting of water, low aromatic mineral oil, high aromatic mineral oil, vegetable oil, kerosene, diesel, fuel oil, esters, internal olefins, polyalphaolefins, paraffins, ethylene glycol, propylene glycol and mixtures thereof.

19. The method of claim 12 wherein the liquid composition further comprises a biocide, a thickener and an inhibitor.

20. The method of claim 19 wherein the thickener comprises a polymeric material selected from the group consisting of guar gum and derivatives thereof, locust bean gum, tara, konjak, tamarind, starch, cellulose, karaya gum, xanthan gum, tragacanth gum, arabic gum, ghatti gum, tamarind gum, carrageenan and derivatives thereof, carboxymethyl guar, hydroxypropyl guar, carboxymethylhydroxypropyl guar, polyacrylate, polymethacrylate, polyacrylamide, maleic anhydride, methylvinyl ether copolymers, polyvinyl alcohol, polyvinylpyrrolidone, carboxyethylcellulose, carboxymethylcellulose, carboxymethylhydroxyethylcellulose, hydroxyethylcellulose, hydroxypropylcellulose, methylhydroxypropylcellulose, methylcellulose, ethylcellulose, propylcellulose, ethylcarboxymethylcellulose, methylethylcellulose, hydroxypropylmethylcellulose, bentonite, attapulgite and laponite.

21. The method of claim 20, wherein the thickener is selected from the group consisting of hydroxyethylcellulose, carboxymethylhydroxyethylcellulose and guar gum.

22. A method of cementing a subterranean zone, comprising:
preparing a cement slurry;
preparing a liquid composition comprising greater than about 2.0 percent of an active gas generating additive by weight of the cement wherein the active gas generating additive is selected from the group consisting of aluminum powder and azodicarbonamide;
pumping the cement slurry into the subterranean zone;
injecting the liquid composition into the cement slurry to form a cementing composition as the cement slurry is being pumped into the subterranean zone; and
allowing the cementing composition to set in the subterranean zone.

23. The method of claim 22, wherein the active gas generating additive is coated or encapsulated with a surfactant and the surfactant is a fatty acid ester of sorbitan, glycerol or pentaerythritol.

24. The method of claim 23 wherein the surfactant is selected from the group consisting of sorbitan monooleate, sorbitan monoricinoleate, sorbitan monotallate, sorbitan monoisostearate, sorbitan monostearate, glycerol monoricinoleate, glycerol monostearate, pentaerythritol monoricinoleate, and mixtures thereof.

25. The method of claim 24 wherein the surfactant comprises sorbitan monooleate.

26. The method of claim 22 wherein the cement slurry comprises Portland cement, pozzolan cement, gypsum cement, aluminous cement, silica cement, or alkaline cement.

27. The method of claim 22 wherein the cement slurry comprises class A, G or H Portland cement.

28. The method of claim 22 wherein the liquid composition comprises a liquid medium selected from the group consisting of water, low aromatic mineral oil, high aromatic mineral oil, vegetable oil, kerosene, diesel, fuel oil, esters, internal olefins, polyalphaolefins, paraffins, ethylene glycol, propylene glycol and mixtures thereof.

29. The method of claim 22 wherein the liquid composition further comprises a biocide, a thickener and an inhibitor.

30. The method of claim 29 wherein the thickener comprises a polymeric material selected from the group consisting of guar gum and derivatives thereof, locust bean gum, tara, konjak, tamarind, starch, cellulose, karaya gum, xanthan gum, tragacanth gum, arabic gum, ghatti gum, tamarind gum, carrageenan and derivatives thereof, carboxymethyl guar, hydroxypropyl guar, carboxymethylhydroxypropyl guar, polyacrylate, polymethacrylate, polyacrylamide, maleic anhydride, methylvinyl ether copolymers, polyvinyl alcohol, polyvinylpyrrolidone, carboxyethylcellulose, carboxymethylcellulose, carboxymethylhydroxyethylcellulose, hydroxyethylcellulose, hydroxypropylcellulose, methylhydroxypropylcellulose, methylcellulose, ethylcellulose, propylcellulose, ethylcarboxymethylcellulose, methylethylcellulose, hydroxypropylmethylcellulose, bentonite, attapulgite and laponite.

31. The method of claim 30, wherein the thickener is selected from the group consisting of hydroxyethylcellulose, carboxymethylhydroxyethylcellulose and guar gum.

32. A cementing composition comprising:
cement and a liquid composition comprising an active gas generating additive selected from the group consisting of aluminum powder and azodicarbonamide, wherein the active gas generating additive is coated or encapsulated with a surfactant and the surfactant is a fatty acid ester of sorbitan, glycerol or pentaerythritol.

33. The cementing composition of claim 32 wherein the surfactant is selected from the group consisting of sorbitan monooleate, sorbitan monoricinoleate, sorbitan monotallate, sorbitan monoisostearate, sorbitan monostearate, glycerol monoricinoleate, glycerol monostearate, pentaerythritol monoricinoleate, and mixtures thereof.

34. The cementing composition of claim 33 wherein the surfactant comprises sorbitan monooleate.

35. The cementing composition of claim 32 wherein the cement comprises Portland cement, pozzolan cement, gypsum cement, aluminous cement, silica cement, or alkaline cement.

36. The cementing composition of claim 32 wherein the cement is class A, G or H Portland cement.

37. The cementing composition of claim 32 wherein the cementing composition comprises from about 0.3 to about 5.0 percent of the active gas generating additive by weight of the cement.

38. The cementing composition of claim 32 wherein the cementing composition comprises greater than about 2.0 percent of the active gas generating additive by weight of the cement.

39. The cementing composition of claim 32 wherein the liquid composition comprises a liquid medium selected from the group consisting of water, low aromatic mineral oil, high aromatic mineral oil, vegetable oil, kerosene, diesel, fuel oil, esters, internal olefins, polyalphaolefins, paraffins, ethylene glycol, propylene glycol and mixtures thereof.

40. The cementing composition of claim 32 wherein the liquid composition further comprises a biocide, a thickener and an inhibitor.

41. The cementing composition of claim 40 wherein the thickener comprises a polymeric material selected from the group consisting of guar gum and derivatives thereof, locust bean gum, tara, konjak, tamarind, starch, cellulose, karaya gum, xanthan gum, tragacanth gum, arabic gum, ghatti gum, tamarind gum, carrageenan and derivatives thereof, carboxymethyl guar, hydroxypropyl guar, carboxymethylhydroxypropyl guar, polyacrylate, polymethacrylate, polyacrylamide, maleic anhydride, methylvinyl ether copolymers, polyvinyl alcohol, polyvinylpyrrolidone, carboxyethylcellulose, carboxymethylcellulose, carboxymethylhydroxyethylcellulose, hydroxyethylcellulose, hydroxypropylcellulose, methylhydroxypropylcellulose, methylcellulose, ethylcellulose, propylcellulose, ethylcarboxymethylcellulose, methylethylcellulose, hydroxypropylmethylcellulose, bentonite, attapulgite and laponite.

42. The cementing composition of claim 41, wherein the thickener is selected from the group consisting of hydroxyethylcellulose, carboxymethylhydroxyethylcellulose and guar gum.

43. A cementing composition comprising:
cement and a liquid composition comprising from about 0.3 to about 5.0 percent of an active gas generating additive by weight of the cement wherein the active gas generating additive is selected from the group consisting of aluminum powder and azodicarbonamide.

44. The cementing composition of claim 43, wherein the active gas generating additive is coated or encapsulated with a surfactant and the surfactant is a fatty acid ester of sorbitan, glycerol or pentaerythritol.

45. The cementing composition of claim 44 wherein the surfactant is selected from the group consisting of sorbitan monooleate, sorbitan monoricinoleate, sorbitan monotallate, sorbitan monoisostearate, sorbitan monostearate, glycerol monoricinoleate, glycerol monostearate, pentaerythritol monoricinoleate, and mixtures thereof.

46. The cementing composition of claim 45 wherein the surfactant comprises sorbitan monooleate.

47. The cementing composition of claim 43 wherein the cement comprises Portland cement, pozzolan cement, gypsum cement, aluminous cement, silica cement, or alkaline cement.

48. The cementing composition of claim 43 wherein the cement is class A, G or H Portland cement.

49. The cementing composition of claim 43 wherein the liquid composition comprises a liquid medium selected from the group consisting of water, low aromatic mineral oil, high aromatic mineral oil, vegetable oil, kerosene, diesel, fuel oil, esters, internal olefins, polyalphaolefins, paraffins, ethylene glycol, propylene glycol and mixtures thereof.

50. The cementing composition of claim 43 wherein the liquid composition further comprises a biocide, a thickener and an inhibitor.

51. The cementing composition of claim 50 wherein the thickener comprises a polymeric material selected from the group consisting of guar gum and derivatives thereof, locust bean gum, tara, konjak, tamarind, starch, cellulose, karaya gum, xanthan gum, tragacanth gum, arabic gum, ghatti gum, tamarind gum, carrageenan and derivatives thereof, carboxymethyl guar, hydroxypropyl guar, carboxymethylhydroxypropyl guar, polyacrylate, polymethacrylate, polyacrylamide, maleic anhydride, methylvinyl ether copolymers, polyvinyl alcohol, polyvinylpyrrolidone, carboxyethylcellulose, carboxymethylcellulose, carboxymethylhydroxyethylcellulose, hydroxyethylcellulose, hydroxypropylcellulose, methylhydroxypropylcellulose, methylcellulose, ethylcellulose, propylcellulose, ethylcarboxymethylcellulose, methylethylcellulose, hydroxypropylmethylcellulose, bentonite, attapulgite and laponite.

52. The cementing composition of claim 51, wherein the thickener is selected from the group consisting of hydroxyethylcellulose, carboxymethylhydroxyethylcellulose and guar gum.

53. A cementing composition comprising:
cement and a liquid composition comprising greater than about 2.0 percent of an active gas generating additive by weight of the cement wherein the active gas generating additive is selected from the group consisting of aluminum powder and azodicarbonamide.

54. The cementing composition of claim 53, wherein the active gas generating additive is coated or encapsulated with a surfactant and the surfactant is a fatty acid ester of sorbitan, glycerol or pentaerythritol.

55. The cementing composition of claim 54 wherein the surfactant is selected from the group consisting of sorbitan monooleate, sorbitan monoricinoleate, sorbitan monotallate, sorbitan monoisostearate, sorbitan monostearate, glycerol monoricinoleate, glycerol monostearate, pentaerythritol monoricinoleate, and mixtures thereof.

56. The cementing composition of claim 55 wherein the surfactant comprises sorbitan monooleate.

57. The cementing composition of claim 53 wherein the cement comprises Portland cement, pozzolan cement, gypsum cement, aluminous cement, silica cement, or alkaline cement.

58. The cementing composition of claim 53 wherein the cement is class A, G or H Portland cement.

59. The cementing composition of claim 53 wherein the liquid composition comprises a liquid medium selected from the group consisting of water, low aromatic mineral oil, high aromatic mineral oil, vegetable oil, kerosene, diesel, fuel oil, esters, internal olefins, polyalphaolefins, paraffins, ethylene glycol, propylene glycol and mixtures thereof.

60. The cementing composition of claim 53 wherein the liquid composition further comprises a biocide, a thickener and an inhibitor.

61. The cementing composition of claim 60 wherein the thickener comprises a polymeric material selected from the group consisting of guar gum and derivatives thereof, locust bean gum, tara, konjak, tamarind, starch, cellulose, karaya gum, xanthan gum, tragacanth gum, arabic gum, ghatti gum, tamarind gum, carrageenan and derivatives thereof, carboxymethyl guar, hydroxypropyl guar, carboxymethylhydroxypropyl guar, polyacrylate, polymethacrylate, polyacrylamide, maleic anhydride, methylvinyl ether copolymers, polyvinyl alcohol, polyvinylpyrrolidone, carboxyethylcellulose, carboxymethylcellulose, carboxymethylhydroxyethylcellulose, hydroxyethylcellulose, hydroxypropylcellulose, methylhydroxypropylcellulose, methylcellulose, ethylcellulose, propylcellulose, ethylcarboxymethylcellulose, methylethylcellulose, hydroxypropylmethylcellulose, bentonite, attapulgite and laponite.

62. The cementing composition of claim 61, wherein the thickener is selected from the group consisting of hydroxyethylcellulose, carboxymethylhydroxyethylcellulose and guar gum.
